(19) United States
(12) Patent Application Publication
(10) Pub. No.: US 2003/0038722 A1
(43) Pub. Date: Feb. 27, 2003

(54) In-vehicle human presence detection and aid system, and associated method

(75) Inventors: Farid Khairallah, Farmington Hills, MI (US); Stephen R.W. Cooper, Fowlerville, MI (US); Nicholas M. Zayan, Fenton, MI (US); Jon K. Wallace, Redford, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 09/934,624

(22) Filed: Aug. 22, 2001

(51) Int. Cl. B60Q 1/00

(52) U.S. Cl. 340/584; 180/271; 701/45; 701/49

(57) ABSTRACT

A system (10) has a portion (e.g., 30, 42 and 44) for sensing the presence of a person in a vehicle interior compartment (e.g., 20). The system (10) also has a portion (e.g., 34 and 50) for determining if the temperature in the vehicle interior compartment (20) is potentially dangerous to the person. The system (10) further has a portion (e.g., 60, and 66, 68, 70, or 72) responsive to the determination of potentially dangerous temperature for providing aid to the person in the vehicle interior compartment (20). An associated method includes sensing the presence of a person in a vehicle interior compartment, determining if a temperature condition exists in the vehicle interior compartment that is potentially dangerous to the person, and providing aid to the person in the vehicle interior compartment in response to the determination.

### BACKGROUND OF THE INVENTION

1. Technical Field

The present invention relates to a vehicle occupant protection system. In particular, the present invention relates to a system for detecting the presence of a person in a vehicle interior with a dangerously high or low temperature and for, in response, providing aid to the person.

2. Description of Related Art

It is known to sense the presence of a person in an interior of a vehicle and, in response, control actuation of a vehicle occupant protection device, such as an air bag. It is also known to sense the presence of a vehicle condition, such as an actuated air bag inflator, and in response send a radio transmission to alert someone outside the vehicle as to the existence of the vehicle condition.

### SUMMARY OF THE INVENTION

In accordance with one aspect, the present invention provides a system that includes means for sensing the presence of a person in a vehicle interior compartment. The system also includes means for determining if the temperature in the vehicle interior compartment is potentially dangerous to the person. The system further includes means responsive to the determining means for providing aid to the person in the vehicle interior compartment.

In accordance with another aspect, the present invention provides a method having the steps of sensing the presence of a person in a vehicle interior compartment, determining if a temperature condition exists in the vehicle interior compartment that is potentially dangerous to the person, and providing aid to the person in the vehicle interior compartment in response to the determination.

### BRIEF DESCRIPTION OF THE DRAWINGS

The foregoing and other features and advantages of the invention will become apparent to one skilled in the art to which the invention relates upon consideration of the following description of the invention with reference to the accompanying drawings, in which:

FIG. 1 is a schematic diagram of a vehicle that includes an occupant protection system in which the present invention is incorporated;

FIG. 2 is a functional block diagram of a controller that forms part of the system of FIG. 1; and

FIG. 3 is a flow chart showing a process in accordance with the present invention.

### DESCRIPTION OF AN EXAMPLE EMBODIMENT

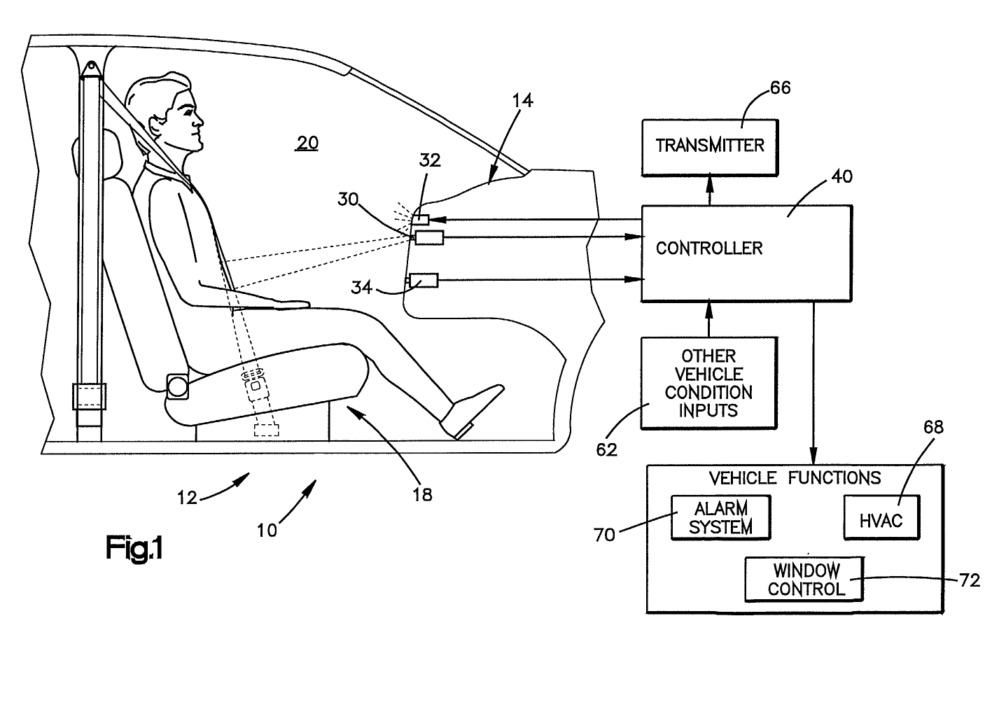

The present invention relates to a vehicle occupant protection system. In particular, the present invention relates to a system and method for detecting the presence of a person in a vehicle interior with a dangerously high or low temperature and for, in response, providing aid to the human. As representative of the present invention, FIG. 1 illustrates schematically a system 10 in accordance with the present invention. The system 10 is provided for a vehicle 12, such as a passenger car.

The vehicle 12 includes an instrument panel 14. The vehicle 12 also includes a vehicle seat 18, which is illustrated as a front passenger seat of the vehicle. The seat 18 is disposed in an occupant compartment 20 of the vehicle 12, rearward of the instrument panel 14.

The system 10 includes one or more devices 30 for detecting the presence of a person in the vehicle 12. In one example, one device 30 is provided in the form of an imager for gathering a visual image of a vehicle interior area. Further, in the example, the imager 30 is mounted on the vehicle 12 for image gathering within the vehicle occupant compartment 20 of the vehicle 12. In the illustrated embodiment, the imager 30 gathers a visual image of the portion of the vehicle occupant compartment 20 that includes the seat 18. As such the imager 30 is associated with detection of the presence of a person in the vehicle occupant compartment 20.

The imager 30 is operative to provide an output signal representative of the visual appearance of the imaged portion of the vehicle occupant compartment 20, and any object, such as a person, located within the imaged area. The imager 30 may be a CMOS camera or another type of camera such as a CCD camera.

More than one imager 30 may be used. The number of imagers 30 that are used may depend on the size of the vehicle, the number of rows of seats, etc. For example, a vehicle with three rows of seats may require a large number of imagers 30 to be able to visualize footwells, etc. An imager 30 may also be mounted in a vehicle trunk interior area (not shown).

The system 10 may also provide illumination for the imaged area (e.g., the portion of the vehicle occupant compartment 20). The illumination is provided by one or more light sources, such as the light source indicated schematically at 32 mounted in the vehicle instrument panel 14. Such illumination may be needed for proper visual imaging of the vehicle occupant compartment 20 by the imager 30 in low ambient light situations or no ambient light (darkness) situations. Of course, it is to be appreciated that non-illumination imaging (e.g., low-light or infrared) is contemplated for the present invention.

The system 10 also includes one or more devices 34 for determining the temperature inside the vehicle (e.g., the occupant compartment 20). In the illustrated embodiment, a single device 34 is provided, which is a temperature sensor. The temperature sensor 34 is mounted on the vehicle 12 so as to be able to sense excessively high or low temperatures in the vehicle occupant compartment 20, i.e., life threatening temperatures. Alternatively, the system 10 may determine the temperature inside the vehicle occupant compartment 20 by requesting a temperature reading from the vehicle HVAC (heating, ventilation, and air conditioning) system through the vehicle communication bus (not shown).

The system 10 includes a controller 40. The controller 40 is electrically connected with the imager 30, the light source 32, the temperature sensor 34, other electric circuitry of the vehicle (e.g., the vehicle power supply), and with the other components of the system 10 described below.

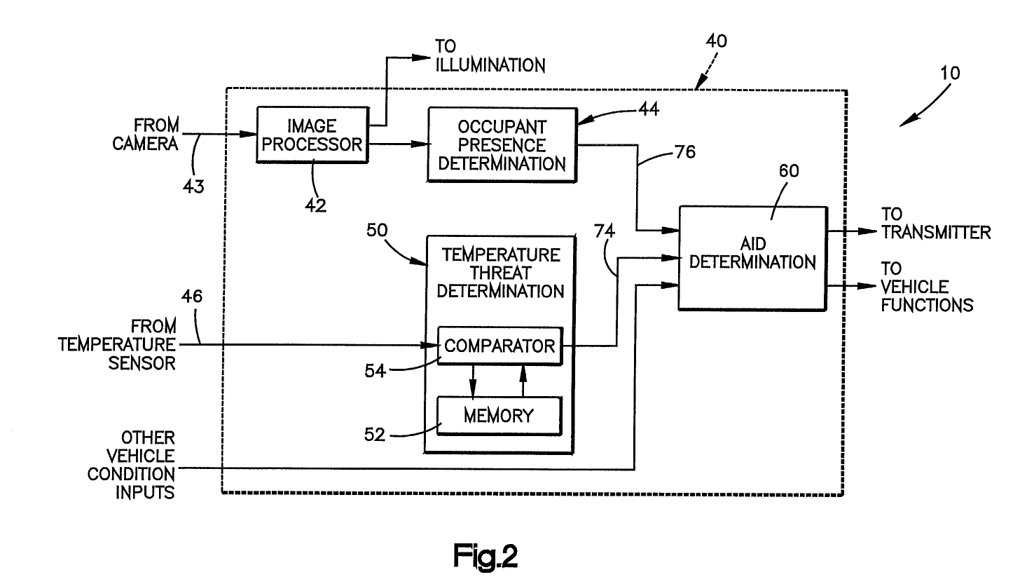

The controller 40 (FIG. 2) includes an image processor 42. The imager 30 provides an output 43 to the image processor 42. The image processor 42 receives the output 43 of the imager and processes it to a form usable to make a determination as to the presence of an occupant in the vehicle 12.

The image processor 42 is also operative to control the light source 32. Thus, if the image processor 42 determines that there is not sufficient light in the vehicle occupant compartment 20 to obtain a usable image of the vehicle occupant compartment, then the image processor 42 can cause the light source 32 to be energized.

The controller 40 to make a determination as to the presence of an occupant in the vehicle 12 uses the output from the image processor 42. Specifically, the controller 40 includes circuitry 44 for making an occupant presence determination on the basis of the information provided by the image processor 42. The circuitry 44 includes software algorithms for reading the output of the imager 30 and, in response, determining if a person is present in the vehicle occupant compartment 20. This type of algorithm is known and used in conjunction with, for example, the actuation of air bag inflators.

The temperature sensor 34 provides an output 46 to the controller 40. The controller 40 in determining whether a temperature threat exists in the vehicle occupant compartment 20 uses the output 46 from the temperature sensor 34.

Specifically, the controller 40 includes circuitry 50 for making a temperature threat determination on the basis of the information provided by the temperature sensor 34. The circuitry 50 includes a memory 52 in which are stored values corresponding to certain temperatures. The circuitry 50 includes a comparator 54 operative to compare the output from the temperature sensors 34 with the stored values in the memory 52, and make a determination as to whether the temperature in the vehicle occupant compartment 20 may be a life-threatening temperature. For example, the circuitry 50 may be programmed to read any temperature above 120 degrees Fahrenheit as a life-threatening temperature. Also, the circuitry 50 may be programmed to read any temperature below 40 degrees Fahrenheit as a life-threatening temperature.

The controller 40 also includes circuitry 60 for making an aid determination, as described below, on the basis of the outputs of the occupant presence determination circuitry 44 and the temperature threat circuitry 50.

In the presented example, the system 10 provides one or more additional inputs 62 (FIG. 1) to the controller 40. For example, the inputs 62 may include an input indicative of whether the vehicle engine is on or off. One input 62 may be indicative of whether the vehicle radio is on or off. Another input 62 indicative of whether the vehicle HVAC system 64 (FIG. 1) is on or off. These other inputs 62 can be used by the controller 12 in determining whether an emergency situation exists in the vehicle occupant compartment 20.

In the example, the system 10 includes one or more transmitters 66, which are preferably RF transmitters. The transmitters 66 may operate on one or more frequencies and be directed to one or more modes of communication, for example, cellular phone communication.

Also in the example, the controller 40 is connected with one or more vehicle devices for controlling the functions of those device(s). For example, the controller 40 in the illustrated embodiment is connected with the vehicle HVAC system 68, for turning on the vehicle engine and HVAC system as needed to adjust or relieve the temperature in the vehicle occupant compartment 20. The controller 40 in the illustrated embodiment is connected with the vehicle alarm system 70, for activating the vehicle alarm system. The controller 40 is also connected with the vehicle window control system 72, for opening one or more electrically operated vehicle windows as needed to adjust or relieve the temperature in the vehicle occupant compartment 20.

In operation of the system 10 (FIG. 2), the output signal 46 of the temperature sensor 34 is directed to the temperature threat determination circuitry 50 in the controller 40. The comparator 54 compares the value of the output signal 46 to the set of values stored in the memory 52 in the controller 40. If the value of the output signal 46 is determined to be outside a predetermined range, which represents temperatures of an acceptable value, the controller 40 determines that the temperature in the vehicle occupant compartment 20 is possibly life-threatening if there is a person in the vehicle occupant compartment. An appropriate output signal 74 is sent to the aid determination circuitry 60.

The output signal of the imager 30 is directed to the image processor 42, and the output of the image processor to the occupant presence determination circuitry 44. The occupant presence determination circuitry 44 determines if a person is present in the vehicle occupant compartment 20. An appropriate output signal 76 is sent to the aid determination circuitry 60.

The aid determination circuitry 60 initially determines the presence of an emergency situation if both (a) the output signal 74 indicative of temperature indicates a life-threatening temperature and (b) the output signal 76 indicative of occupant presence indicates the presence of a person in the vehicle occupant compartment 20. The system 10 also looks, however, at one or more of the vehicle condition inputs 62. For example, if the vehicle ignition and radio are on and the HVAC system 64 is on, the system 10 may in some cases assume that the vehicle 12 is safely under the control of an adult and that no emergency situation exists regardless of the temperature in the vehicle occupant compartment 20.

When the controller 40 makes a determination that aid is needed, the system 10 provides aid to the person in the vehicle 12. The aid is provided in one or more of several different ways.

The controller 40 can activate the transmitter 66. When activated, the transmitter 66 may place a cellular telephone call to a 911 system, to a pager, or to a cell phone. The transmitter 66 may send a wireless signal to a personal digital assistant via the Internet, or to a computer via e-mail. The signal that is broadcast may be an alert of a predetermined nature, or may include voice and/or visual data. The transmitter 66 may broadcast a visual image, taken by the imager 30.

The party receiving the wireless alert can provide aid to the person in the vehicle 12. For example, the party may cause or direct the vehicle driver to return to the vehicle 12. Alternatively, the party receiving the alert may proceed to the vehicle 12, or may notify another party, such as the police. Preferably, the party receiving the alert is the operator of the vehicle 12, receiving the alert via a portable device, such as a cell phone or pager. The vehicle operator, having received the alert, can return to the vehicle 12 to attend to the situation.

The controller 40 may, in addition or alternatively, act to turn on the vehicle engine and/or HVAC system 64 to relieve the temperature in the vehicle occupant compartment 20. The controller may also activate the vehicle alarm 66. The controller 40 may also cause the vehicle window control system 68 to open one or more of the vehicle windows in order to relieve the temperature in the vehicle occupant compartment 20.

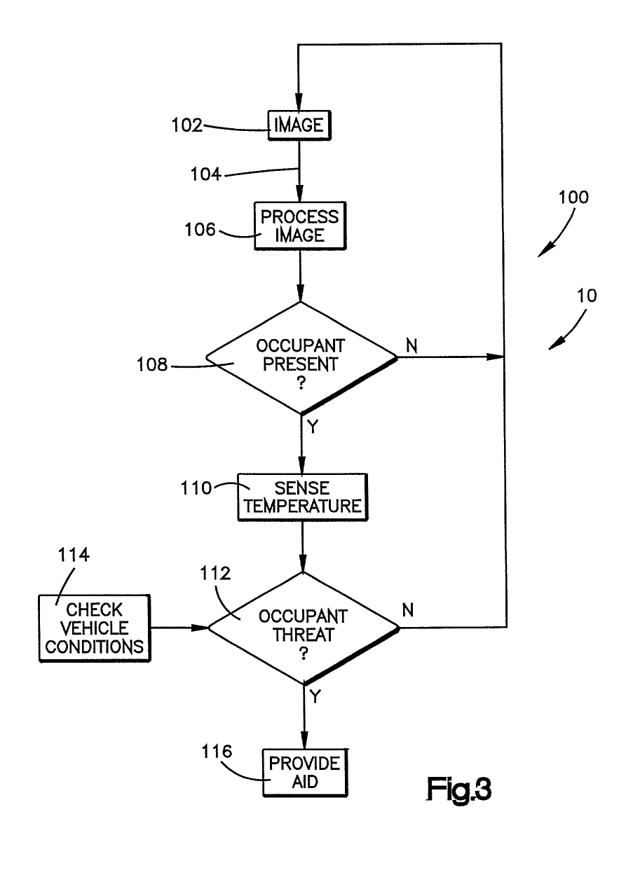

FIG. 3 is a flow chart of a process 100 that is in accordance with the present invention. The process 100 begins at step 102, in which the interior of the vehicle occupant compartment is imaged. The output 104 of the imager is processed at 106, and an occupant presence determination is made at step 108.

If the result of the occupant presence determination 108 indicates that there is no occupant in the vehicle occupant compartment, the process 100 loops back to the beginning.

If, on the other hand, the result of the occupant presence determination 108 indicates that there is an occupant present in the vehicle occupant compartment, the process proceeds to step 110. At step 110 the temperature in the vehicle occupant compartment is sensed. Simultaneously, other vehicle conditions are checked at step 112, to determine whether the vehicle engine is running, whether the vehicle HVAC system is running, etc.

On the basis of the output of the temperature sensor, and taking into account the other vehicle condition inputs, an occupant threat determination is made at step 114. If the result of the occupant threat determination 114 indicates that there is no threat to the occupant in the vehicle occupant compartment, the process 100 loops back to the beginning. If, on the other hand, the result of the occupant threat determination 114 indicates that there is a threat to an occupant in the vehicle occupant compartment, then aid is provided at step 116, in a manner as described above.

From the above description of the invention, those skilled in the art will perceive improvements, changes and modifications in the invention. Such improvements, changes and modifications within the skill of the art are intended to be covered by the appended claims.

Having described the invention, we claim:

1. A system comprising:
means for sensing the presence of a person in a vehicle interior compartment;
means for determining if the temperature in the vehicle interior compartment is potentially dangerous to the person; and
means responsive to said determining means for providing aid to the person in the vehicle interior compartment.

2. A system as set forth in claim 1 wherein said means for determining comprises at least one temperature sensor mountable in the vehicle interior compartment for providing an output signal, a memory having stored temperature values, and comparison means for comparing said output signal with said stored temperature values.

3. A system as set forth in claim 2 wherein said sensing means comprises at least one imager.

4. A system as set forth in claim 3 wherein said means for providing aid comprises means for providing an alert signal to a location outside the vehicle interior compartment.

5. A system as set forth in claim 4 wherein said means for providing an alert signal comprises means for providing a wireless signal transmission to a location outside the vehicle interior compartment.

6. A system as set forth in claim 3 wherein said means for providing aid comprises means for relieving the temperature inside the vehicle interior compartment.

7. A system as set forth in claim 1 wherein said sensing means comprises at least one imager.

8. A system as set forth in claim 7 wherein said means for providing aid to the person comprises means for signaling to a location outside the vehicle.

9. A system comprising:
at least one imager means for sensing the presence of a person in a vehicle interior compartment;
means for determining if the temperature in the vehicle interior compartment is potentially dangerous to the person, comprising at least one temperature sensor mountable in the vehicle interior compartment for providing an output signal, a memory having stored temperature values, and comparison means for comparing said output signal with said stored temperature values;
means responsive to said determining means for providing aid to the person in the vehicle interior compartment, comprising means for providing a wireless signal transmission to a location outside the vehicle interior compartment and means for relieving the temperature inside the vehicle interior compartment.

10. A method comprising the steps of:
sensing the presence of a person in a vehicle interior compartment;
determining if a temperature condition exists in the vehicle interior compartment that is potentially dangerous to the person; and
providing aid to the person in the vehicle interior compartment in response to said determination.

11. A method as set forth in claim 10 wherein said sensing step comprises sensing the presence of a person in the vehicle interior compartment with an imager.

12. A method as set forth in claim 10 wherein said determining step comprises sensing the temperature in the vehicle interior compartment and determining if the sensed temperature is outside a predetermined range of acceptable values.

13. A method as set forth in claim 10 wherein said step of providing aid comprises providing an alert signal to a location outside the vehicle interior compartment.

14. A method as set forth in claim 13 wherein said step of providing an alert signal comprises providing a wireless signal transmission to a location outside the vehicle interior compartment.

15. A method as set forth in claim 10 wherein said step of providing aid comprises relieving the temperature inside the vehicle interior compartment.

16. A method comprising the steps of:
sensing the presence of a person in a vehicle interior compartment with an imager;
determining if a condition exists in the vehicle interior compartment that is potentially dangerous to the person by sensing the temperature in the vehicle interior compartment and determining if the sensed temperature is outside a predetermined range of acceptable values; and
providing aid to the person in the vehicle interior compartment in response to said determination by providing an alert signal to a location outside the vehicle interior compartment and by relieving the temperature inside the vehicle interior compartment.
